(19) United States
(12) Patent Application Publication
(10) Pub. No.: US 2012/0320075 A1
(43) Pub. Date: Dec. 20, 2012

(54) SYSTEM FOR IMPLEMENTING UNIFORM DISPLAY ATTRIBUTES

(76) Inventors: S. DAVID SILK, BARRINGTON, IL (US); DAN CHIN, LINCOLNWOOD, IL (US)

(21) Appl. No.: 13/162,777

(22) Filed: Jun. 17, 2011

(51) Int. Cl. G09G 5/00

(52) U.S. Cl. 345/581

(57) ABSTRACT

A system is provided for updating attributes of a display for rendering an image. The system includes a tool, a host device, and a monitor including the display. The tool is utilized by the user to define the desired display attributes and to create and export a configuration file which includes the attribute information. The tool allows for creation of the configuration file without requiring the user to have knowledge of the firmware associated with the display. The configuration file is received by the host device. During operation of the display and upon the occurrence of a triggering event, the host device provides updates to the memory addresses of a display controller to effectuate updates to the display attributes. The system includes a host agent and a display agent and provides the ability to update memory addresses of the display controller which are unassigned under the communications standard utilized. The bandwidth for communication between the host agent and the monitor is maximized through the use of profile triggered events. If desired, a single host agent is utilized to provide update dates to multiple displays. Additionally, the configuration file is received by multiple host devices to uniformly define the attributes of multiple displays.

### FIELD OF THE INVENTION

This invention is generally directed to a system and method for updating display attributes without updating the firmware associated with the display and for providing the updated display attributes to a plurality of displays.

### BACKGROUND OF THE INVENTION

Currently, uniform configuration of a plurality of video displays is achieved through the use of firmware installed on a microcontroller attached to each display. The display firmware typically provides information utilized to define the attributes of the image rendered on the display such as brightness, contrast, etc. When a customer desires changes to be made to the display attributes, the firmware is updated to effectuate the desired changes. A problem with this approach is that customers do not typically have sufficient knowledge of the firmware to effectuate the desired changes to the display attributes. Additionally, although the manufacturer has intimate knowledge of the display's firmware, once the display has been shipped to the customer, revisions/updates to the firmware are cumbersome and require the manufacturer to reprogram/re-flash the firmware altogether.

United States Patent Application Publication 2007/0174418 (“the '418 Publication”) is entitled Display Firmware Upgrade Without External Devices and describes a method for updating the firmware of a display. As described by the '418 Publication, the firmware upgrades are achieved when the user executes the firmware upgrade utility software 222 to upgrade the firmware 260 of the display 205. As described at paragraph [0024] execution of the firmware upgrade utility software 222 generates a plurality of instructions to upgrade the firmware 260. These firmware instructions are only carried out when the display is in a non-operating or off-line state. Updates to the display firmware occur, for example, upon boot up of the display. The '418 Publication, therefore, results in a static change to the display attributes. Dynamic changes to the display attributes are not achieved.

The present invention overcomes problems presented in the prior art and provides additional advantages over the prior art. Such advantages will become clear upon a reading of the attached specification in combination with a study of the drawings.

### SUMMARY OF THE INVENTION

Briefly, the present invention discloses a system and method for defining attributes of a display which is in communication with a host device. These display attributes are defined without requiring an update to the firmware of the display and therefore no knowledge of the firmware is required by the user. The invention provides for dynamic updates to the display attributes.

The invention includes a first software program which includes a graphical user interface and provides the user with a user-friendly means for defining the desired display attributes. The first software program further includes profiles which are utilized to efficiently define multiple display attributes. A configuration file is generated by the first software program. The configuration file includes information regarding the desired display attributes and regarding the defined profiles. The configuration file is presented to the central processing unit of the host device. A second software program is provided on the host device and on the monitor. This second software program receives the configuration file and communicates the display attribute information to the monitor via a graphics controller. A microcontroller of the monitor receives the desired display attribute information and communicates the display attribute information to the display via the display controller.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a block diagram of the system of the present invention;

FIG. 2a illustrates the graphical user interface provided by the user tool of the present invention;

FIG. 2b illustrates an example of a configuration file defined by the user tool;

FIG. 3a is a flow diagram illustrating the prior art method of updating the display attributes; and

FIG. 3b is a flow diagram illustrating the method of the present invention for updating display attributes.

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

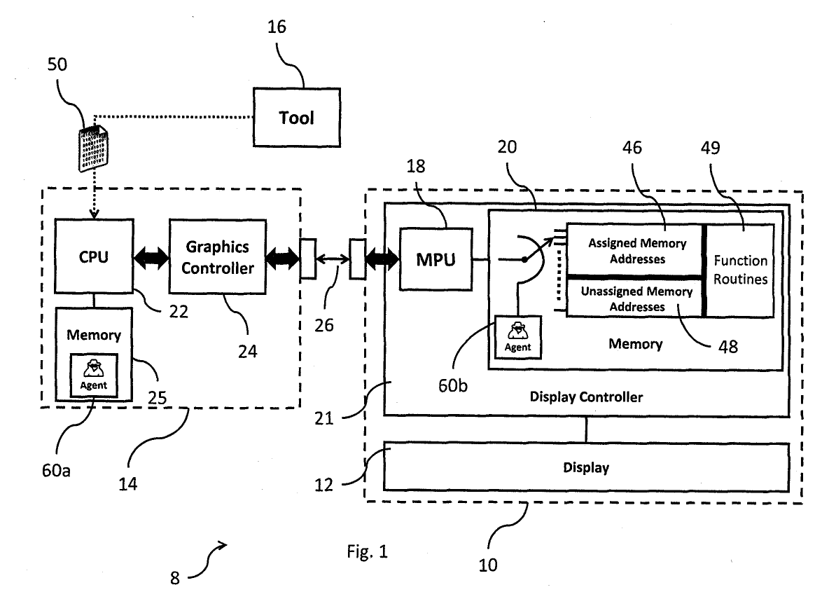

The system 8 of the current invention is illustrated in FIG. 1. The system generally includes a monitor 10 including a display 12 for which the desired display attributes are to be defined, a host device 14 in communication with the monitor 10 for communicating the desired display attributes to the monitor 10, and a tool 16 for communicating the desired display attributes to the display 12. The host device 14, can be for example, a gaming machine which is in communication with the monitor 10.

As noted above, the monitor 10 includes the display 12 in communication with a microcontroller (MPU) 18, memory 20, and a display controller 21. The host device 14 includes a central processing unit (CPU) 22 in communication with a memory 25 and a graphics controller 24. An interface cable 26 allows for communication between the host device 14 and the monitor 10.

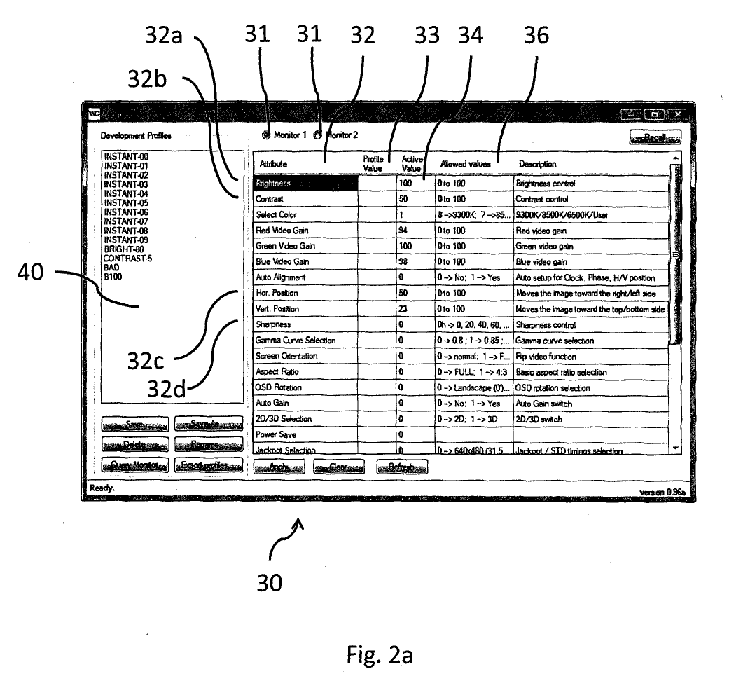

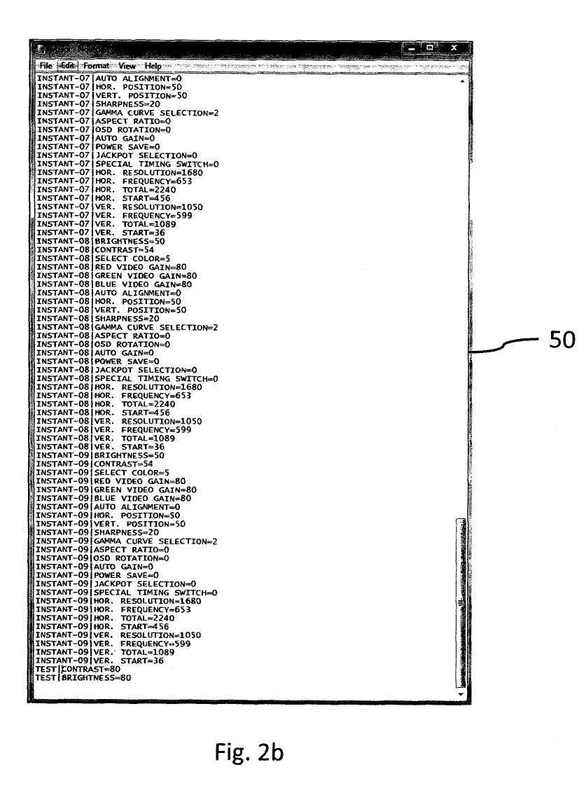

The tool 16 is a software program which is preferably provided on a customer's evaluation platform. The tool 16 allows the user to define the desired attributes of the display 12 to render the video content in the desired manner. The tool 16 includes a graphical user interface to present the user with options for defining the display attributes in an easy-to-use manner, i.e. in a manner which does not require the user to have knowledge of the inner workings of the display's firmware. An embodiment of the graphical user interface 30 is illustrated in FIG. 2a. The interface 30 includes a list of the display attributes 32 along with an associated profile value 33, an associate active value 34, and an allowed value 36 for each display attribute 32. Display attributes 32 include, for example, brightness 32a, contrast 32b, Horizontal Position 32c, and Sharpness 32d. Many other attributes are listed in FIG. 2a and it is to be understood that the list illustrated in FIG. 2a is a partial list and that additional display attributes are included in the present invention. In addition, if the user would like to access an attribute of the display 12 which is not identified by the tool 16, the user may request that the tool be modified to accommodate the additional attribute. The list of allowed values 36 defines the range of values which the user may associate with each display attribute 32. For example, an integer value in the range from 0 to 100 may be selected for the display attribute Brightness 32a. If the user wants to increase the brightness of the display, the user simply increases the integer value presented in the Active Value column 34 for the field associated with the display attribute Brightness 32a.

The host device 14 is often provided in communication with a plurality of monitors 10. As shown in FIG. 2a, the tool 16 includes a monitor selection field 31 to allow the user to select the monitor in order to provide an indication as to which monitor the attributes will be defined by the user. If for example, “monitor 1” is selected, the list of the display attributes 32, profile value 33, active value 34, and allowed value 36 for each display attribute 32 of a first monitor will be shown and can be modified by the user. On the other hand, if “monitor 2” is selected, the list of the display attributes 32, profile value 33, active value 34, and allowed value 36 for each display attribute 32 of a second monitor will be shown and can be modified by the user. Although, FIG. 2a illustrates that the tool 16 is configured to allow the user to define the attributes of a first and second monitor, it is to be understood, that the tool 16 can be configured to accommodate additional monitors if desired.

The tool 16 is also configured to provide for the creation and selection of profiles. As illustrated in FIG. 2a, the graphical user interface 30 presents a selection of profiles 40 which are configured by the manufacturer of the monitor 10 or the user of the monitor 10. Each profile 40 is configured to set or update a number of the display attributes 32 to a pre-determined value as defined by the manufacturer or customer. Upon selection of a profile 40 the pre-determined value associated with the attribute will be displayed in the profile value field 33. Updates to the tool 16 can be made at anytime to accommodate the user's preferences. These updates can be achieved through the use of additional or revised profiles 40.

The use of a profile 40 allows several display attributes 32 to be “batched” together to minimize the user's effort and simplifies implementation in the field. This simplified manner of updating several data fields provides efficiency and ensures greater uniformity when updating the display attributes 32 of multiple displays 12. For example, if the user will be implementing a number of monitors 10 in a first environment which requires configuration of a first set of display attributes of the displays 12 of those monitors 10 in a first manner and an additional monitors 10 will be implemented in a second environment which requires configuration of a second set of display attributes in another manner, the tool 16 can be utilized to provide an appropriate profile 40 for each environment. Rather than requiring the user to identify and set each of the display attributes in the first set for each display to be implemented in the first environment or to identify and set each of the display attributes in the second set for each display 12 to be implemented in the second environment, the tool 16 can be configured accordingly to simplify the process for the user. The tool 16 is configured, for example, to present the user with the selection of a user defined profile 40 for environment #1 or environment #2. Upon the user's selection of the profile 40 relating to environment #1, the tool 16 is configured to update the profile value 33 column as defined by the profile. When the selection of the profile 40 is applied, the active value 34 data fields relating to the appropriate display attributes 32 are updated to appropriately define the first set of display attributes. Alternatively, upon the user's selection of the profile 40 relating to environment #2, the tool 16 is configured to update the profile value 33 column as defined by the profile. When the selection of the profile 40 relating to environment #2 is applied, the active value 34 data fields relating to the appropriate display attributes 32 are updated to appropriately define the second set of display attributes.

In the preferred embodiment of the invention, two classes of profiles are utilized; sequential profiles and instantaneous profiles. FIG. 2a illustrates examples of each classification of profiles. Sequential profiles illustrated in FIG. 2a include BRIGHT-80, CONTRAST-5, BAD and B100. Instantaneous profiles illustrated in FIG. 2a include INSTANT-00 through INSTANT-09. The utilization of these types of profiles is described herein.

Any information regarding the active values 34 which the user has associated with the display attributes 32 and any information regarding the profiles 40 are stored in a configuration file 50 associated with the tool 16. An example of a configuration file 50 is shown in FIG. 2b. Once all of the display attributes 32 have been defined by the user and the profiles 40 have been defined, the tool 16 is configured to export the configuration file 50 which includes the attribute and profile information from the tool 16. The configuration file 50 is received by the CPU 22 of the host device 14.

As noted above, the monitor 10 includes a display controller 21. The display controller 21 includes a plurality of addresses 46, 48 for communication of instructions to the display 12 and a plurality of function routines 49 associated with the addresses 46, 48. The addresses 46 of the display controller 21 are assigned in accordance with an appropriate communication standard, e.g. a standard defined by the Video Electronics Standards Association (VESA) such as the Display Data Channel Command Interface (DDC/CI) standard. This standard was designed to accommodate a fixed number of addresses, however, only a portion of this fixed number of addresses are assigned/utilized under the DDC/CI standard. The remainder of the addresses are unassigned. These unassigned addresses 48 are intended to accommodate future developments, such as, for example, new display characteristics not envisioned at the time the standard was developed.

A second software program, referred to herein as an “agent” includes two portions a host agent 60a and a monitor agent 60b. The host agent 60a is installed on memory 25 associated with the host device 14 and the monitor agent 60b is installed on memory 20 associated with the monitor 10. The agents 60a, 60b provide for communication of the information in the configuration file 50 to the display 12 as illustrated in FIG. 1.

The host agent 60a receives the configuration file 50 prepared and exported from the tool 16. The configuration file received by the host agent 60a includes attribute and profile information. The configuration file 50 includes information to be provided to the assigned memory addresses 46 and customized attribute information to be provided to the unassigned memory addresses 48 of the display controller 21, i.e., memory addresses which are not assigned to a particular function routine 49.

The host agent 60a translates the configuration file 50 into information which can be communicated by the CPU 22 to the graphics controller 24. This information includes information relating to profiles and information relating to attributes which were not previously accounted for in the communications standard of the display controller 21. When a triggering event occurs, the graphics controller 24, via the interface cable 26, transmits the information to the monitor agent 60b of the MPU 18. Triggering events may be, for example, initiation of a particular game on the host device 14, or a particular event within a game running on the host device 14. The interface cable 26 can use any one of a number of physical layer link solutions for transferring the information, such as for example, I²C, USB, DisplayPort or Thunderbolt. Although the interface cable 26 has been described, it is to be understood that connection between the host device and the monitor can be made in a wireless manner. Additionally, it is to be understood that a graphics controller 24 may not be necessary to provide communication between the host device 14 and the monitor 10.

The monitor agent 60b, which is in communication with the MPU 18, receives the information provided for the assigned and unassigned addresses of the display controller 21. The monitor agent 60b translates the information received from the graphics controller 24 to the appropriate memory addresses of the display controller 21. The customized attribute information is provided to the unassigned addresses of the display controller 21. The display controller 21 includes a number of function routines 49. Each function routine is associated with a memory address of the display controller 21. E.g. memory address 010 of the display controller 21 is associated with a function routine 49 used to set brightness; memory address 012 of the display controller 21 is associated with a function routine used to set contrast, etc. The MPU 18 is configured to periodically scan the addresses 46, 48 of the display device controller 21. When upon scanning the addresses the MPU 18 determines that an update has occurred, the appropriate function routine 49 is called to provide the information associated with the memory address 46, 48 to the display 12 and the function routine effectuates the desired display attributes on the display 12.

As noted above, in some instances the host device 14 communicates with multiple monitors 10. Each monitor 10 includes a display 12 and a display controller 21. The display 12 of each monitor 10 may be configured to render images in a different manner than the remaining displays 12 associated with the host device 14. In these instances the configuration file 50 includes information relating to each monitor 10 associated with the display host device 14. The agent 60a is configured to communicate with each monitor 10 and provides updates to the addresses 46, 48 of each display controller 21.

In one example, a customer desires to define brightness of the display 12 and to activate the parallax filter of the display 12. An assigned memory address 46 is used to control the brightness function routine 49 and an unassigned memory address 48 is used to control a function routine 49 for turning on or off the parallax filter to enable the monitor to render the 3D content. The parallax barrier function routine 49 is not associated with any of the addresses defined by the VESA Standard. More specifically, no portion of the DDC/CI communications standard is assigned for providing parallax filter information to the display 12. Memory address E5 of the display controller 21 is unassigned under the DDC/CI communications standard and is therefore used to hold the parallax filter information, i.e. to designate whether the parallax filter of the display 12 is to be set in the “on” or “off” mode. The host agent 60a, therefore, is configured to receive the configuration file 50 and provide information regarding brightness and information regarding the parallax filter to the host graphics controller 24 and to define the association of the information received with the appropriate addresses 46, 48. Upon the occurrence of a triggering event, the graphics controller 24 provides this information to the monitor agent 60b of the MPU 18. The monitor agent 60b translates the brightness information to the assigned memory address 46 and the parallax filter information to the unassigned memory address E5 of the display controller 21. Specifically a “1” is placed on memory address 48 of the display controller 21. When the MPU 18 scans the registers of the display controller 21, the update to the addresses is recognized and the appropriate function routines 49 are called upon to adjust the brightness and to turn on the parallax filter of the display 12.

By utilizing the additional capacity provided by the unassigned addresses of the communication standard, the software agent 60a, 60b is configured to provide additional commands to the display 12 which were not previously accommodated in the communications standard. The user is therefore provided with a convenient means for accessing additional capabilities of the display 12.

The agent 60a provides the ability to simultaneously update several addresses of the display controller 21 with a single command. In other words, the agent 60a provides the ability to update several addresses in a “batch” form. As noted above, the configuration file 50 includes attribute information and profile information. As described above, the host agent 60a is configured to update individual attributes upon the occurrence of triggering events. Additionally or alternatively, the host agent 60a is configured to update a plurality of attributes upon the occurrence of profile triggering events by using the profile information from the configuration file 50. Specifically, upon the occurrence of a profile triggering event, the host agent 60a is configured to update all attribute fields associated with a profile 40 and provide the updated attribute information to the MPU 18. The agent 60b associated with the monitor MPU 18 is configured to receive this information and in response update several memory addresses of the display controller 21.

As noted above, two types of profiles are utilized; sequential profiles and instantaneous profiles. Sequential profiles provide for a sequential update of the associated attributes. For example, if five attributes are associated with the sequential profile, the information relating to the first attribute will be provided over the interface cable 26, followed by the information relating to the second attribute, and so on, until the information relating to the fifth attribute is provided over the interface cable 26.

Instantaneous profiles are utilized in a different manner. Upon initialization or boot up of the monitor 10, the host agent 60a is configured to provide the instantaneous profile information to the graphics controller 24 and to the monitor agent 60b and the instantaneous profile information is stored in the memory of the monitor 10. When the host agent 60a receives confirmation of a profile triggering event associated with the instantaneous profile, an instruction to activate the profile is provided by the graphics controller 24 to the monitor agent 60b via the interface cable 26. Upon receipt of the instruction to activate the instantaneous profile, the attribute information associated with each attribute defined by the instantaneous profile is provided to the appropriate memory addresses of the display controller 21. Use of the instantaneous profile, therefore, allows a single profile activation instruction to be provided over the interface cable 26 during operation of the monitor 10 in order to update several memory addresses of the display controller 21. Thus, the information to be provided over the interface cable 26 during operation of the monitor 10 is minimized.

Instantaneous profiles may also be utilized when the host device 14 communicates with a number of monitors 10. In this case, upon initialization or boot up of each monitor 10, the host agent 60a is configured to provide instantaneous profile information to the monitor agent 60b associated with each monitor 10 and the appropriate instantaneous profile information is stored in the memory of each monitor 10. When the host agent 60a receives confirmation of a profile triggering event associated with an instantaneous profile, the instruction to activate the profile is provided to the display agent 60b. Upon receipt of the instruction to activate the instantaneous profile, the attribute information associated with each attribute defined by the instantaneous profile is provided to the appropriate memory address of the appropriate controller 21.

As described above, the attributes of the display 12 are updated without requiring an update to the display firmware of the monitor 10 in contrast to the prior art which requires updates to the firmware. The user is not required, therefore, to have a working knowledge of the display firmware.

Updates to the display attributes, which occur as a result of firmware updates, occur when the display is in a boot-up/initialization mode. These firmware updates only allow for static updates to the display attributes. In contrast, the updates to the display attributes provided by the present invention provide for updates that can occur during the operational mode of the display. Use of the agents 60a, 60b in connection with triggering events therefore provide the ability to update the display attribute information to the display 12 in a dynamic fashion. The ability to provide dynamically defined display attributes without requiring any updates to the firmware of the monitor 10 provides the customer with increased flexibility.

The agent 60a, 60b can be utilized to provide updated display attributes to the display 12 as frequently as desired by the user. In order to maximize the bandwidth of the interface cable 26, instantaneous profiles are utilized. By providing the attributes associated with the instantaneous profiles to the memory of the monitor 10 at initialization, during operation, a single instruction can be carried by the interface cable upon the occurrence of the triggering event, however, all attributes associated with the display 12 will be updated at the display controller 21. Thus, even when updates are requested by the user very frequently, the delay in rendering the image is minimized.

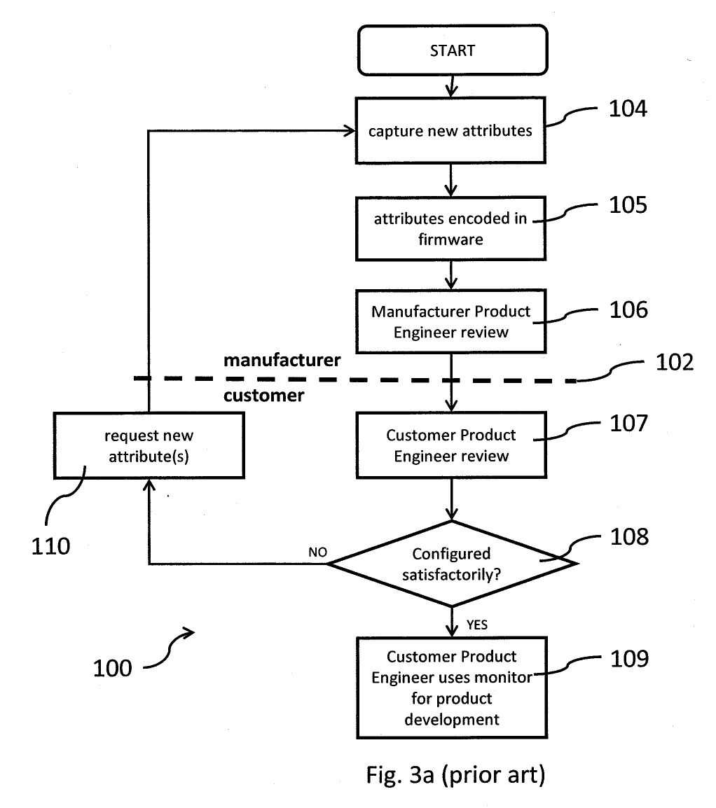

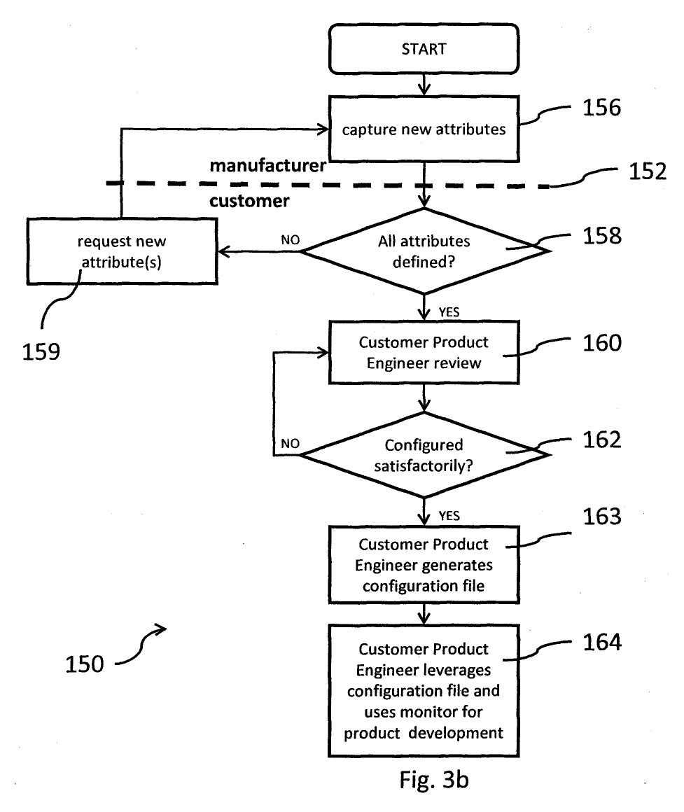

Use of the invention results in cost efficiencies, time efficiencies and added flexibility to the customer. As noted above, in the past updates to the display attributes required an intimate knowledge of the display firmware associated with the monitor 10. The previous methodology 100 of achieving updates to the display attributes is illustrated in FIG. 3a. Steps of the methodology 100 performed by the monitor manufacturer are provided above line 102 and steps performed by the customer are provided below the line 102. As shown in FIG. 3a, the method begins at step 104 wherein the manufacturer collects preliminary display attributes from the customer to provide an initial sample. Next, at step 105 the manufacturer encodes the preliminary display attributes in the display firmware of the monitor 10. Next, at step 106, the product engineer of the manufacturer reviews the display attributes to confirm compliance with the customer's requirements provided at step 104. If compliance is achieved, the display is then shipped to the customer. Next, at step 107 the product engineer of the customer reviews the display attributes to confirm compliance with the customer's requirements. Next, if at step 108 it is determined that the display is configured satisfactorily, at step 109 the display is ready to be incorporated into the final product for mass production. If, however, at step 108 the product engineer of the customer determines that the display is not satisfactorily configured, the monitor is returned to the monitor manufacturer, and at step 110 the revised and/or new display attributes are communicated to the monitor manufacturer and the process can begin again from step 104.

The new methodology 150 achieved with implementation of the present invention is illustrated in FIG. 3b. Steps of the methodology 150 performed by the monitor manufacturer are provided above the line 152 and steps performed by the customer are provided below the line 152. As shown in FIG. 3b, the method begins at step 156 where the manufacture identifies and captures the display attributes to be defined, i.e. the manufacturer configures the tool 16, and the agent 60a, 60b to set or reset the desired attributes of the display 12. Next, at step 158 the customer determines if any new display attributes desired are not currently accommodated by the tool 16. If at step 158, the customer determines that each of the desired display attributes is not included in the list of attributes 32 of the tool 16, at step 159 the customer requests definition of the desired attribute in the tool 16 by the monitor manufacturer. Unlike prior art, the monitor does not have to be returned to the monitor manufacturer and the monitor manufacturer can simply revise the list of attributes 32 remotely minimizing disruption to the customer. Next, at step 156 the manufacturer captures the newly defined attributes in the tool and provides the customer with the revised tool 16. The process then returns to step 158 where the customer reviews the tool 16 to determine whether the desired attributes are defined within the tool 16. If at step 158 the user determines that all desired attributes are defined, the user may then proceed to step 160. At step 160, the customer product engineer defines the display attributes and profiles until at step 162 the product engineer of the customer is satisfied. If at step 162, the display attributes are satisfactorily defined, then at step 163, the product engineer of the customer generates the configuration file 50. At the next step 164, using the configuration file 50, the monitor is ready to be used in the product development cycle and prepared for mass production. Using the configuration file, the updates to the display attributes are applied uniformly to as many displays as desired by the customer.

The invention obviates the need to iteratively revise the display firmware each time the customer desires new display attributes. As can be observed from FIG. 3b, in most cases, knowledge of the firmware is not necessary to implement new display attributes and many of the steps needed to implement new display attributes defined by the customer may be completed entirely by the customer. Involvement from the monitor manufacturer is required only when the particular display attribute desired by the customer is not capable of being defined by the customer using the display attributes 32 provided in the tool 16. In that situation, the manufacturer will update the tool 16 to accommodate the new display attribute. Because in many cases the customer can complete implementation of the new display attributes without involvement from the monitor manufacturer, the time in which the customer can bring the product to market is reduced. Because the customer has the tool 16 to implement the revisions, the customer can implement revisions much later in the product development cycle, affording greater flexibility in the development cycle. The increase flexibility avoids costs associated with changes late in the development cycle.

While a preferred embodiment of the present invention is shown and described, it is envisioned that those skilled in the art may devise various modifications of the present invention without departing from the spirit and scope of the invention.

The invention claimed is:

1. A system for defining attributes of a display used to render an image comprising:
a monitor including the display, a display controller including a plurality of memory addresses for storing display attribute information, said display controller in communication with the display, and a monitor agent in communication with said display controller;
a host device in communication with the monitor, a host agent configured to respond to a triggering event, and a configuration file including attribute information regarding the image to be rendered; and
wherein upon occurrence of said triggering event and during an operating mode of the display, at least one of said plurality of memory addresses of said display controller is updated based upon information in said configuration file.

2. The system of claim 1, wherein said configuration file defines at least one profile including information regarding a plurality of display attributes;
wherein said host device is configured to respond to a profile triggering event; and
wherein upon the occurrence of said profile triggering event, a plurality of memory addresses of said display controller are updated based upon said at least one profile defined by said configuration file.

3. The system of claim 1, wherein said monitor further includes a memory in communication with said display device controller;
wherein said configuration file defines as least one profile including information regarding a plurality of display attributes;
wherein said host device is configured to respond to a profile triggering event;
wherein upon initialization, said host device is configured to provide said information regarding a plurality of display attributes to said memory; and
wherein upon the occurrence of a profile triggering event, a plurality of memory addresses of said display controller are updated based upon said information in said memory.

4. The system of claim 1, further including a tool for defining the attributes of the display, wherein said tool is configured to present data entry fields relating to the display attributes, to receive data input in said data entry fields, and to create an exportable configuration file based on data entered into said data entry fields; and wherein said configuration file includes information for association with memory addresses of said display controller.

5. The system of claim 4, wherein said configuration file includes profile information.

6. The system of claim 1, wherein information in said configuration file includes information to be associated with addresses of the display controller which are not assigned in accordance with a communication protocol.

7. The system of claim 6, wherein said memory addresses are assigned pursuant to a Video Electronics Standard Association Display Data Channel Command Interface protocol.

8. The system of claim 1 wherein said communication between said host device and said monitor is provided wirelessly.

9. The system of claim 1 further comprising:
a second monitor in communication with said host device, said second monitor including a second display, a second display controller including a plurality of memory addresses for storing display attribute information, said second display controller in communication with said second display, and a second monitor agent in communication with said second display controller;
wherein upon occurrence of said triggering event and during an operating mode of the second display, at least one of said plurality of memory addresses of said second display controller is updated based upon information in said configuration file.

10. A method of configuring display attributes of a display used to render an image comprising the steps of:
providing a monitor including, the display, a display controller in communication with said display, said display controller including a plurality of memory addresses for storing display attribute information, and a monitor agent in communication with said display controller;
providing a host device in communication with the monitor, the host device including a configuration file having display attribute information and a host agent configured to respond to a triggering event;
receiving confirmation that said triggering event has occurred;
communicating display attribute information from said host device to the addresses of said display controller in response to said triggering event; and
activating function routines associated with the addresses of said display controller to update the display attributes based upon the information at the addresses of said display controller.

11. The method of claim 10, wherein said configuration file of said host device includes at least one profile including information regarding a plurality of display attributes and said host agent is configured to response to a profile triggering event; further comprising the steps of:
receiving confirmation that said profile triggering event has occurred;
communicating display attribute information from said host device to the addresses of said display controller in response to said profile triggering event; and
activating function routines associated with the addresses of said display controller to update the display attributes based upon the information at the addresses of said display controller.

12. The method of claim 10 further comprising the steps of:
providing a second monitor in communication with said host device, said second monitor including a second display, a second display controller in communication with said second display, said second display controller including a plurality of memory addresses for storing display attribute information, and a second monitor agent in communication with said second display controller;
communicating display attribute information from said host device to the addresses of said second display controller in response to said triggering event; and
activating function routines associated with the addresses of said second display controller to update the display attributes based upon the information at the addresses of said second display controller.

13. The method of claim 10, wherein said configuration file of said host device includes at least one profile including information regarding a plurality of display attributes and said host agent is configured to response to a profile triggering event; further comprising the steps of:
upon initialization of said monitor, providing said at least one profile including information regarding a plurality of display attributes to a monitor memory;
receiving confirmation that said profile triggering event has occurred;
providing a profile activation command from said host device to said monitor;
communicating display attribute information from said monitor memory to the addresses of said display controller in response to said profile triggering event; and
activating function routines associated with the addresses of said display controller to update the display attributes based upon the information at the addresses of said display controller.

14. The method of claim 10 further comprising the steps of:
providing a second monitor in communication with said host device, said second monitor including a second display, a second display controller in communication with said second display, said second display controller including a plurality of memory addresses for storing display attribute information, and a second monitor agent in communication with said second display controller;
upon initialization of said second monitor, providing said at least one profile including information regarding a plurality of display attributes to a monitor memory of said second monitor;
receiving confirmation that said profile triggering event has occurred;
providing a profile activation command from said host device to said second monitor;
communicating display attribute information from said second monitor memory to the addresses of said second display controller in response to said profile triggering event; and
activating function routines associated with the addresses of said second display controller to update the second display attributes based upon the information at the addresses of said second display controller.

15. The method of claim 10, further comprising the steps of:
providing a tool for defining the attributes of the display, wherein said tool is configured to present data entry fields relating to said display attributes;
receiving data input in said data entry fields;
configuring an exportable configuration file based on data entered in said data entry fields; and
exporting said configuration file from said tool.

16. The method of claim 15, further comprising the step of receiving said configuration file by said host agent.

17. The method of claim 16, wherein said step of receiving said configuration file is repeated in connection with a second host agent of a second host device.

18. A method of utilizing addresses of a display controller unassigned under a communication protocol to modify display attributes, comprising the steps of:
providing a host device including a host agent;
providing a monitor in communication with said host device, said monitor including a monitor agent and a display controller including a plurality of memory addresses, wherein at least a portion of said memory address are unassigned under the communications protocol associated with said display controller,
during operation of the monitor and upon the occurrence of a triggering event, communicating information from said host agent to said the unassigned addresses of the display controller; and
providing information from said unassigned memory addresses of said display controller to said display to control attributes of said display.

19. The method of claim 18, wherein said monitor further includes a memory, further comprising the step of:
upon initialization of said display, providing profile information to a memory of said display;
in response to a profile triggering event, providing a profile activation instruction from said host agent to said monitor agent;
updating at least one memory address of said display device controller in response to said profile activation instruction based upon said profile information in said memory of said display.
